(19) United States
(12) Patent Application Publication
(10) Pub. No.: US 2005/0200032 A1
(43) Pub. Date: Sep. 15, 2005

(54) Polymer optical articles

(76) Inventors: R.F. Gao, Downingtown, PA (US); A.F. Garito, Radnor, PA (US); A. Yeniay, Wayne, PA (US)

Correspondence Address: Min, Hsieh & Hack, LLP;c/o PortfolioIP, P.O. Box 52050, Minneapolis, MN, 55402, US

(21) Appl. No.: 11/075,725

(22) Filed: Mar. 9, 2005

Related U.S. Application Data
(60) Provisional application No. 60/551,043, filed on Mar. 9, 2004.

(51) Int. Cl. B29D 11/00

(52) U.S. Cl. 264/1.24; 264/1.31; 264/1.32

(57) ABSTRACT

Polymeric optical elements and method for making a polymeric optical elements are provided. The method can include forming a solution by dissolving a polymer in a solvent or melting a polymer to form a liquid. The solution can be filtered with a first filter comprising a pore size of 10 microns or less. The solution can be further filtered with a second filter, wherein the second filter comprises sintered metal. A polymeric optical element can then be formed from the solution.

### CROSS-REFERENCE TO RELATED APPLICATIONS

This application claims priority to U.S. Provisional Patent Application Ser. No. 60/551,043 filed on Mar. 9, 2004, the disclosure of which is incorporated by reference herein in its entirety.

### TECHNICAL FIELD

The invention generally relates to polymeric optical elements and, more particularly, to polymeric optical articles formed from halogenated polymer and perfluoropolymer materials.

### BACKGROUND

Photonic waveguide technologies, including silica on silicon, InP and polymers offer potential platforms for highly integrated, cost-effective, compact, high functional, and reliable photonic devices and systems. Although the InP platform has potential in many applications, measurements have shown that the waveguide loss and polarization dependence are prohibitively high for efficient and compact waveguide devices. As for silica on silicon, although it has the potential of low excess waveguide loss, the associated active coefficients such as thermo-optic (TO) and electro-optic (EO) effects, in contrast to InP or polymers, are relatively low, and manufacturing difficulties are among the drawbacks. In comparison, transparent polymer materials are used as optical media in photonic devices and systems because of their outstanding features. These include: ease in design of optical properties; ultra low optical loss; high TO and EO coefficients; low thermal conductivity; ease in processing; ease in device fabrication; high-density, monolithic device integration; ease in athermal device operation; high thermal, mechanical, chemical, and moisture stabilities; and high volume, high speed, scalable, parallel, cost effective manufacturing methods.

However, achieving these features requires considerable care in the polymer materials preparation and processing, aiming toward ultra pure, substantially particle free polymer solutions by removing solid particles, for example, larger than approximately 20 nm in diameter. Problems arise, however, because conventional filters, such as polymer membranes, used in liquid solution filtration are inadequate for a number of important reasons. For example, polymer membranes usually have relatively large filter pore size (above approximately 100 nm in diameter), poor resistance to fluoro- or perfluoro-carbon solvents, high initial solid debris and particle content, high susceptibility to electrostatic build up, and high fragility and damage under applied pressure commonly used in attempting to filter a relatively viscous solution.

Thus, there is a need to overcome these and other problems of the prior art and to provide a filter and a method for filtering polymers for photonic waveguides, fibers, and optical articles.

### SUMMARY OF THE INVENTION

According to various embodiments, the present teachings provide a method for making a polymeric optical article. The method can include dissolving a polymer in a solvent to form a solution and filtering the solution with a first filter comprising a pore size of 10 microns or less. The solution can be filtered with a second filter, wherein the second filter comprises sintered metal. A polymeric optical article can then be made from the solution.

According to various embodiments, the present teachings also provide a method for making a polymeric photonic waveguide. The method can include melting a polymer to form a liquid and filtering the liquid with a first filter having a pore size of 10 microns or less. The liquid can be filtered with a second filter comprising a sintered metal. The polymeric photonic waveguide can then be formed from the liquid.

According to various embodiments, the present teachings further provide a polymeric optical article. The polymer optical article can be made by dissolving a polymer in a solvent to form a solution and filtering the solution with a first filter having a pore size of 10 microns or less. The solution can be filtered with a second filter comprising a sintered metal. The polymeric optical article can then be formed from the solution.

### BRIEF DESCRIPTION OF THE DRAWINGS

FIG. 1 depicts a method for making a polymeric optical article in accordance with an exemplary embodiment of the invention.

FIG. 2 depicts another method for making a polymeric optical article in accordance with an exemplary embodiment of the invention.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the present invention. The following description is, therefore, not to be taken in a limited sense.

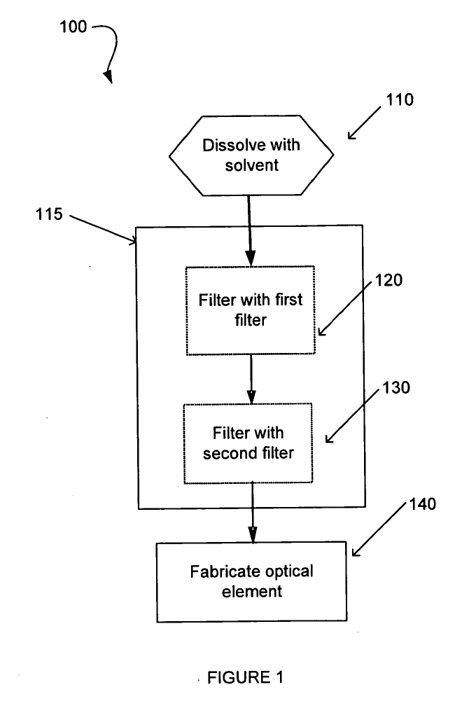

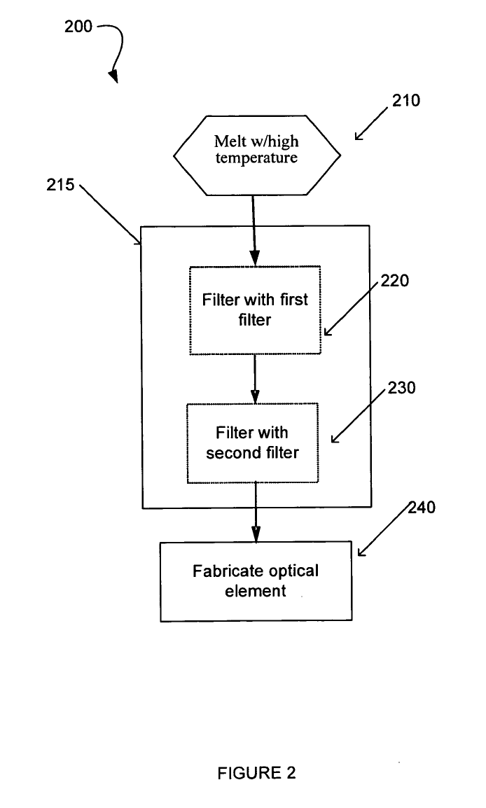

FIGS. 1 and 2 depict exemplary embodiments of a nanofabrication technology used to fabricate halogenated polymer optical articles that are ultra low loss, polarization insensitive, and a thermal. In some embodiments, the halogenated polymer can be fluoro- or perfluoropolymers.

The disclosed halogenated polymer waveguide materials have the above advantages while exhibiting ultra low optical loss generally in the visible-infrared range together with higher material reliability. The disclosed methods of preparation result in ultra pure, substantially particle free halogenated polymer solutions required in fabricating halogenated polymer waveguides including thin films and multi layer stacks by spin coating, casting, spraying, or dipping. In various embodiments, solid particles, for example, larger than approximately 20 nm in diameter can be effectively removed by methods disclosed herein. This can be accomplished even in cases where halogenated polymer solutions for optical thin film devices have high viscosity, low surface energy, and strong electrostatic properties.

In accordance with various embodiments, an exemplary method 100 for making polymer optical articles is shown in FIG. 1. At 110, a polymer, such as, for example, a halogenated polymer, fluoro-, or perfluoropolymer, can be dissolved in a solvent to form a solution. The solvent can be, for example, a suitable halo-, fluoro- or perfluoro-carbon solvent, such as, for example, C₆F₁₄, CFC113, CF₃CHFCHFCF₂CF₃, HCFC225, HCFC141B, CF₃CH₂OH, CF₃CF₂CH₂OH, HCF₂CF₂CH₂OH HC₄F₈CH₂OH, (CF₃)₂CHOH, C4F9OCH3, C4F9OCH2CH3, FC-75, HCF₂—O—(CF₂O)ₙ—(CF₂CF₂O)ₘ—CF₂H, C₃F₇O(CFCF₃CF₂O)₂CF-CF₃COOCH₃, 1,3-trifluoromethylbenzene, and N-methyl-2-pyrrolidone. As known to one of ordinary skill in the art, the solvent listed are exemplary and other appropriate solvents can be used. Dissolving can be accomplished, for example, in an appropriately clean steel container.

The solution can then be filtered at 115. In various embodiments, filtering to purify halogenated polymer, fluoro-, and perfluoropolymer solutions can include the use of inorganic filters and/or organic filters, such as polymer membrane filters. In various embodiments, inorganic filters for this use can be sintered metal filters. These filters have a number of desirable features. For example, these filters are mechanically strong and highly resistant to relatively high mechanical stress. Further, they can be heated and thereby used in burning out particles to achieve ultra cleanliness. They also possess excellent resistance to fluoro- and perfluoro-carbon solvents. Further, because sintered metal filters are electrically conductive, there are fewer tendencies toward electrostatic build up that naturally occurs during liquid solution filtration. Moreover, filter pore size of these sintered metal filters can be made extremely small due to the manufacturing method for preparing these filters. In various embodiments, pore size can be as small as 10 nm and less, which is well below the required 20 nm size found empirically. Sintered metal filters can be made from stainless steel, chrome, aluminum, and other appropriate metals and metal alloys. In an exemplary embodiment, sintered filters can be made of ceramic materials. In another exemplary embodiment, a stainless steel filter can be used because of its excellent chemical resistance and strength.

In an exemplary embodiment, filtering at 115 can be a two step process including filtering with a first filter at 120 and filtering with a second filter at 130. The first filter can have a pore size of about 0.7 microns to about 10 microns. The first filter can be membranes or sintered metal.

Filtering with the second filter at 130 can be accomplished using, for example, a sintered metal filter. Filtering with the second filter can also use a low over pressures, for example 10 psi or less. The second filter can have a pore size of about 10 nm to about 1000 nm. The two step filtering can remove particles of 10 nm or more in diameter.

The filtrate can be carefully collected after each filtering step in pre-cleaned containers. The filtered polymer solutions can then be used in the fabrication of polymer optical articles in which the observed optical loss is very sensitive to optical scattering from unwanted residual solid particles. Fabrication can include, for example, spin coating, casting, spraying, or dripping. The polymer optical articles can be, for example, a photonic waveguide, a thin film, a planar waveguide, an optical fiber, a lens, a prism, a disc, or a mirror. The polymer optical articles formed according to the disclosed methods can exhibit a significant reduction in loss, for example, in the wavelength region near 1550 nm, from as high as 0.2 dB/cm and greater, and down to approximately 0.04 dB/cm and less. Similar loss reductions can be noted over the general visible-infrared range. As a consequence, the yield in fabrication of the ultra low loss waveguides can be markedly improved.

Referring to FIG. 2, another exemplary method 200 for making a polymer optical article is provided. At 210, a polymer, such as, for example, a halogenated polymer, fluoro-, or perfluoropolymer, can be melted to form a liquid. The temperature can range from, for example, 0 to 500° C. Melting can be accomplished, for example, in an appropriately clean steel container.

The solution can then be filtered at 215. In an exemplary embodiment, filtering at 215 can be a two step process including filtering with a first filter at 220 and filtering with a second filter at 230. The first filter can have a pore size of about 0.7 microns to about 10 microns and comprise membranes or sintered metal.

Filtering with the second filter at 230 can be accomplished using, for example, a sintered metal filter. Filtering with the second filter can also use a low over pressures, for example 10 psi or less. The second filter can have a pore size of about 10 nm to about 1000 nm. The two step filtering can remove particles of 10 nm or more in diameter.

As before, the filtrate can be carefully collected after each filtering step in pre-cleaned containers. The filtered polymer solutions can then be used in the fabrication of polymer optical articles in which the observed optical loss is very sensitive to optical scattering from any unwanted residual solid particles. Fabrication can include, for example, molding or stanping. The polymer optical articles can be, for example, a photonic waveguide, a thin film, a planar waveguide, an optical fiber, a lens, a prism, a disc, or a mirror that exhibits a significant reduction in loss, for example, in the wavelength region near 1550 nm, from as high as 0.2 dB/cm and greater, and down to approximately 0.04 dB/cm and less. Similar loss reductions can be noted over the general visible-infrared range.

In some embodiments, the filtration method can be used with polymers other than solutions of halogenated polymer, fluoro- or perfluoropolymer materials. The disclosed methods are also generally applicable to most polymer solutions especially those possessing a high viscosity and a solvent compatible with sintered metal. Further, due to the high temperature stability of sintered metal filters, polymer melts can be advantageously filtered following the methods described herein. A filtered polymer melt can then be fabricated into a variety of highly transparent waveguides, including optical articles such as thin films, planar waveguides, fibers, or three dimensional optical parts such as lenses, prisms, discs, mirrors, and other such desirable articles.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

Further, while the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

And, as used herein, the term “one or more of” with respect to a listing of items such as, for example, A and B, means A alone, B alone, or A and B.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for making a polymeric optical article comprising:
dissolving a polymer in a solvent to form a solution;
filtering the solution with a first filter comprising a pore size of 10 microns or less;
filtering the solution with a second filter, wherein the second filter comprises sintered metal; and
forming a polymeric optical article from the solution.

2. The method of claim 1, wherein the polymer is a halogenated polymer.

3. The method of claim 1, wherein the first filter has a pore size of about 0.7 microns to about 10 microns.

4. The method of claim 1, wherein second filter has a pore size of about 10 nm to about 1000 nm.

5. The method of claim 1, wherein the solution is filtered with the second filter at a pressure of 10 psi or less.

6. The method of claim 1, wherein the polymeric optical article is formed by at least one of spin coating, casting, spraying, and dripping.

7. The method of claim 1, wherein filtering by the first filter and the second filter substantially removes particles 10 nm or more in diameter.

8. The method of claim 1, wherein the first filter comprises an inorganic material.

9. The method of claim 1, wherein the polymeric optical article is at least one of a photonic waveguide, a thin film, a planar waveguide, an optical fiber, a lens, a prism, a disc, and a mirror.

10. A method for making a polymeric optical article comprising:
melting a polymer to form a liquid;
filtering the liquid with a first filter having a pore size of 10 microns or less;
filtering the liquid with a second filter comprising a sintered metal; and
forming the polymeric optical article from the liquid.

11. The method of claim 10, wherein the polymer is a halogenated polymer.

12. The method of claim 10, wherein the solution is filtered with the second filter at a pressure of 10 psi or less.

13. The method of claim 10, wherein the first filter has a pore size of about 0.7 microns to about 10 microns.

14. The method of claim 10, wherein the second filter has a pore size of about 10 nm to about 1000 nm.

15. The method of claim 10, wherein filtering by the first filter and the second filter substantially removes particles 10 nm or more in diameter.

16. The method of claim 10, wherein the polymeric optical article is at least one of a photonic waveguide, a thin film, a planar waveguide, an optical fiber, a lens, a prism, a disc, and a mirror.

17. A polymeric optical article formed by a process comprising:
forming a solution by one of dissolving a polymer in a solvent and melting a polymer to form a liquid;
filtering the solution with a first filter having a pore size of 10 microns or less;
filtering the solution with a second filter comprising a sintered metal; and
forming the polymeric optical article from the solution.

18. The polymeric optical article of claim 17, wherein the polymer is a halogenated polymer.

19. The polymeric optical article of claim 17, wherein the polymeric photonic waveguide is substantially free of particles having a diameter larger than 10 nm.

20. The polymeric optical article of claim 17, wherein the optical element is one of a thin film, a planar waveguide, an optical fiber, a lens, a prism, a disc, and a mirror.
